(19) United States
(12) Patent Application Publication
(10) Pub. No.: US 2007/0298771 A1
(43) Pub. Date: Dec. 27, 2007

(54) Method And Device For Routing Communications In Cellular Communications Network

(76) Inventor: Dorron Mottes, Tel-Aviv (IL)

Correspondence Address: PEARL COHEN ZEDEK LATZER, LLP, 1500 BROADWAY 12TH FLOOR, NEW YORK, NY, 10036, US

(21) Appl. No.: 11/791,176

(22) PCT Filed: Nov. 23, 2005
(86) PCT No.: PCT/IL05/01246

§ 371 Date: May 21, 2007

(30) Foreign Application Priority Data
Nov. 24, 2004 (IL) 165362

(51) Int. Cl. H04Q 7/38

(52) U.S. Cl. 455/414.1

(57) ABSTRACT

A method and devices are provided for routing a request to establish a communication session via a communication address associated with a private network, wherein the request is routed via a public cellular network, and for establishing that communication session. The method comprises the steps of: establishing a pre-defined list of telephone numbers belonging to the private network; associating each of the telephone numbers with at least one communication address; defining at least one management rule for handling requests for establishing communication sessions with at least one of the communication addresses; receiving a request to establish a communication session, wherein at least one telephone number selected out of the pre-defined list of telephone numbers is associated with the request; routing the request towards a communication address associated with at least one telephone number, and wherein the routing is carried out in accordance with the at least one management rule; and establishing a communication session between the originator of the arriving request for communication session and a user associated with the communication address, via at least one center of the public cellular network.

### FIELD OF THE INVENTION

The present invention relates in general to the telecommunications field, and in particularly to new solutions in wireless systems.

### BACKGROUND OF THE INVENTION

Many telephone networks have a large number of telephones which are hardwired into the network and which have private access to the network from fixed locations. This requires providing access to the network by using dedicated circuits, such as business telephones through PBX, and the like.

With the ever-growing demand for mobility, one problem associated with such type of operation is how to provide mobile persons with a convenient and inexpensive access to telephone networks. These persons generally have a choice between locating a private-access business or home telephone, or a public-access payphone, which can be inconvenient, and using cellular telephone service, which provides a solution to the mobility problem but can be expensive.

Other problems which may be associated with mobile persons who frequently access wireline telephone networks, such as the need for rerouting calls received at the addressee fixed location while he/she is away from that location.

Another typical problem that arises in certain organizations, is, calls that are made to communicate with a function in the organization rather than a specific person, i.e. customer's services person, marketing person, sales person etc. If a person originating the call dials the number given to him/her and the addressee is away, then either the caller will give up and call another organization or if he/she even chooses to leave a message, there is no way of telling when this message will be heard and acted upon.

One method of wireless contact between a plurality of user stations is described in U.S. Pat. No. 4,672,658. While the system shown therein may achieve the goal of operating a wireless PBX, it is subject to the drawback that it requires complex and relatively expensive user stations, and may not be smoothly integrated into a system for access to telephone networks.

U.S. Pat. No. 6,405,033 discloses system for routing a call using a communications network, where the system includes mobile units, a network switching center, and service centers to provide a variety of traditional and enhanced services to the mobile units. When a user of a mobile unit issues a request for services to be provided from a service center, the network switching center receives the request and, in response, accesses a profile table to select an appropriate service center to establish a communication session with the mobile unit. The selected service center may then provide enhanced services to the mobile unit in order to satisfy the service request.

U.S. Pat. No. 6,771,953 describes provisioning of wireless centrex service that offers the benefits of wireless voice and data services to subscribers having a need to move within a number of localities such as within a business campus. By the method described in this publication, a wireless telephone subscriber can use a standard cellular telephone as a wireless extension of his desktop phone, while being in the proximity of a miniature radio base station capable of communicating with the cellular telephone. Under these conditions, the subscriber can use the same cellular telephone that provides service in the public network, in the wireless centrex environment.

US application 20030193990 discloses a system for accessing a telephone system, in which a set of user stations is matched with a set of base stations for connection to a telephone network. Each base station may be coupled directly or indirectly to the telephone network and is capable of initiating or receiving calls on the telephone network. Each user station may comprise a spread-spectrum transmitter or receiver and may be capable of dynamic connection to selected base stations. A number of base stations are coupled to a private exchange telephone system for coupling user stations in calls outside the telephone network. User stations may make and break connections with base stations as the user station moves between service regions, or is otherwise more advantageously serviced by, base stations. Base stations may be coupled to each other by means of a private exchange telephone system or other small business telephone system (such as a PBX, Centrex, or key-type system) so as to couple user stations in calls outside the telephone network.

Each of these patents and application is hereby incorporated by reference as if fully set forth herein.

### SUMMARY OF THE INVENTION

It is therefore an object of the present invention to allow a more flexible working environment, by providing novel methods and apparatus that enable users that belong to organization telephony network, to operate more efficiently.

It is another object of the invention to provide novel methods and apparatus that enable rerouting of telephone calls and provide a more suitable solution at the organization level.

Other objects of the invention will become apparent as the description of the invention proceeds.

According to a first embodiment of the present invention there is provided a method for routing a request to establish a communication session via a communication address associated with a private network, wherein the request is routed via a public cellular network, and for establishing said communication session, which method comprises the steps of:

establishing a pre-defined list of telephone numbers belonging to said private network;

associating each of said telephone numbers with at least one communication address;

defining at least one management rule for handling requests for establishing communication sessions with at least one of said communication addresses;

receiving a request to establish a communication session, wherein at least one telephone number selected out of said pre-defined list of telephone numbers is associated with said request;

routing said request towards a communication address associated with said at least one telephone number, and wherein said routing is carried out in accordance with said at least one management rule; and

establishing a communication session between the originator of said arriving request for communication session and a user of said communication address, via at least one center of the public cellular network.

The term “communication address” as will be used herein, is used to denote a member of the group consisting of: a wireline telephone number, a cellular telephone number, an e-mail address, a URI (“Uniform Resource Identifier”), a website address, and any combination thereof. Preferably, if a communication address is a cellular telephone number associated with a certain mobile station, at least one other communication address (e.g. another cellular telephone number) will also be associated with that mobile station, so that if a request is received to establish a call with either of the two cellular telephone numbers, it will be transferred to that single mobile station.

By yet another embodiment of the invention, substantially all telephone numbers included in the pre-defined list of telephone numbers, are cellular numbers.

According to yet another aspect of the invention there is provided a cellular network communication device operative to allow establishing of a communication session with a user of a communication address belonging to a private network, which comprises:

means for establishing a pre-defined list of telephone numbers belonging to said private network;

means for associating each of said telephone numbers with at least one communication address;

means for defining at least one management rule for handling requests for establishing communication sessions directed to at least one of said communication addresses;

means for receiving a request to establish a communication session that specifies at least one telephone number which belongs to said pre-defined list of telephone numbers; and

means for establishing a communication session between the request's originator and a user associated with a communication address associated with said at least one telephone number, and wherein said communication session is established in accordance with that at least one management rule.

According to an embodiment of this aspect of the invention, the cellular network communication device further comprising a user buffer operative to store at least one prioritized communication address associated with the user's telephone number, means operative to prevent, in response to a user's request to prevent incoming communication sessions, establishing communication sessions with that user through any of the communication addresses associated with the user's telephone number, and control means operative to determine if a request for communication session arrives to that at least one prioritized communication address, and if in the affirmative, override the means operative to prevent the establishing the communication sessions, and allow establishing that communication session.

By yet another embodiment of the invention, the cellular network communication device further comprises means for providing an indication at the communication address relating to the telephone number specified in the request, before such a communication session is routed towards the at least one center of said public cellular network.

According to still another embodiment of the invention, the cellular network communication device further comprises means for associating a message with the communication session being established for display at the communication address, where such message can be a USSD type of message, or a real time data message transmitted via a data communication channel and the like. Preferably, the message comprises the number called and/or identification of the address of the device initiating the communication session.

By yet another embodiment of the invention, the cellular network communication device further comprises means for initiating a transmittal of audio signals and/or video signals while the communication session with the mobile station is being established or being kept on hold. Preferably, the audio signals and/or video signals are selected in response to identifying the type of the device initiating the call.

According to another embodiment of the invention, the cellular network communication device is adapted to received at least one member of the group consisting of: data signals, voice signal, facsimile signals, video signals and any combination thereof.

### BRIEF DESCRIPTION OF THE DRAWINGS

FIG. 1 is a schematic illustration of a device constructed according to a preferred embodiment of the invention;

FIG. 2 is a schematic view of a system configured in accordance with a preferred embodiment of the invention; and

FIG. 3 is a block diagram illustrating the implementation of a method in accordance with an embodiment of the invention.

### DETAILED DESCRIPTION OF PREFERRED EMBODIMENTS

The present invention will be understood and appreciated more fully from the following non-limiting detailed description.

The solution provided by the present invention, enables wireless operators to provide their business customers with a hosted PBX-like solution, in which the PBX-like extensions are in fact the wireless devices (e.g. even their current wireless devices). Customers may order any amount of extensions they require, so that they instantly expand their private network to include the additional extensions required (wireless devices). Thus, the present invention provides the customers with a flexible solution, simple and easy to use enterprise web management interface, and is a fully distributed mobile extension.

By one embodiment of the invention, all the telephone numbers associated with the private network (the enterprise telephone numbers) are cellular numbers which are typically handled and managed by the public cellular network as a private network. However, by another embodiment of the invention, one or more of the enterprise numbers are wireline numbers which are automatically forwarded to their pre-defined corresponding cellular numbers, so that the caller calls a wireline telephone number and his call is first diverted to the cellular network, and then processed in accordance with the description of the invention as disclosed herein.

According to an embodiment of the invention, the method provided comprises the step of providing an indication to the mobile station which allows the user of that mobile station to identify the telephone number to which the call was addressed, before re-routing the call. This embodiment is particularly useful when more than one telephone number are associated with a single mobile station enabling the user to identify the number to which the call was destined, e.g. if the user of the mobile station belongs to a group of say, sales people or support people, or belongs to a secondary group (for example, when the person receives a call that had not been answered by another mobile station that was supposed to receive that arriving call). Another possibility which becomes more convenient by this embodiment is when a person also uses his/her own mobile telephone as the mobile station, so that the indication will provide the possibility to differentiate between calls that were made to his work number (i.e. those that were re-routed) and private calls made to his/her private mobile telephone.

In addition or in the alternative, for at least one of the telephone numbers included in the pre-defined list, there is more than one corresponding address included in the public cellular network addresses' list, so that a call can be transferred in accordance with a pre-defined routing scheme to more than one address. By the present invention, the various Direct Inward Dialing (“DID”) and groups are managed within the private network and based on the logic rings the telephone, the called number is sent to the user via USSD (or via a real time data message transmitted via a data communication channel, or via SMS generated from the HLR when no USSD exists, or any other methods known in the art per se) Once the user views the message, he/she may see the regular calling message together with the caller's ANI, e.g. by pressing any or certain key of the mobile station. When the end-user places a call, it will have a default ANI. However, he will be able to select a different ANI, based on the DID/called numbers that the end-user may receive. One way of carrying out this embodiment is by selecting the option of trigger on originate, where all IN signaling is routed to the WX node, which analyzes the number, and based on information included in its respective tables, will initiate dialing the default number. In addition or in the alternative, if the caller dialed a pre-defined sign or certain code, it will interpreted as a request to dial the call as if it has been dialed from another line (e.g. a personal line). The WX node will replace the default ANI with the other line's ANI (or any other ANI associated with the other line), and will update the caller's number in the MSC CDR table for billing purposes (replacing the default number with the new originator).

The term Automatic Number Identification (ANI) as will be used herein should be understood to encompass all means and methods known in the art for the identification of the caller, as the case may be, such as ANI, callerID, MSISDN, etc.

Alternatively, an Unstructured Supplementary Service Data (“USSD”) message or DTMF string will indicate to the communication device of the invention, to which ANI should that call be associated with.

By yet another embodiment of the invention, for an arriving call a routing scheme is provided to one of a plurality of addresses out of the list of public cellular network addresses that correspond to one telephone number, and the scheme provides for the selection of a number in accordance with at least one criterion selected from a group consisting of: time of the day, day of the week and national holidays.

In accordance with still another embodiment of the invention, the method provided further comprising a step of preventing the re-routing step in response to a request initiated by the mobile station's user. Preferably, this preventing step further comprises pre-defining a priority list comprising at least one telephone number, so that when a call arrives from other numbers which are not included in this priority list, it will not be routed to that mobile station.

By yet another embodiment, the method provided further comprises a step of associating a message with the call being rerouted for display at said mobile station. Preferably, the message is transmitted to the mobile station by using USSD.

The message may comprise identification of the address of the device initiating the call, such as the automatic number identification (“ANI”) of the device initiating the call.

In addition or in the alternative, the method provided further comprises a step of diverting a call received at the mobile terminal to another station associated with the private network, which can be another mobile terminal, a PC, a wireline telephone, etc.

Preferably, this diversion of the call is made in response to a request initiated by the mobile station user, e.g. by using a pre-defined key associated with that mobile station. Still preferably, a message may be associated with the diverted call, and may be generated in response to a pre-define code sent from the mobile station. The message may be either a visual message (such as USSD message, etc.) or a voice message, depending on the type of device to which the call has been diverted. Thus, while the end user gets an indication of the arriving call (e.g. ringing) he/she can select to divert the call to a third party (e.g. a secretary), and select a notification, which will be presented at the secretary's station (e.g. “please take a message”, “I am busy, will call them later”, “get rid of them”, etc.)

Local option—The transfer can be requested by the mobile station and executed by a switch associated with the private network. In which case, notifications will be stored locally, but there will be a need to synchronize them with the cellular network operation.

Network option—the mobile station sends message the communication device of the invention (the wireless centrex) and that device takes control of the transfer request, manages the process, while instructions such as re-routing schemes etc., are stored at the network's center and are assigned by the wireless centrex, e.g. to the transfer destination.

The message would be sent to the receiving client via USSD. The data sent in such a message is typically data regarding the call information such as ANI, DNIS (called number by number, but can be by done by name, too, if the system of the invention can match it with its own database), in order to enable the receiving phone to generate the right message.

Optionally, the receiving party may view the message and then select from a list of several options, the preferred way of handling the call (e.g. divert the call to secretary, send to voice mailbox, transfer to someone else such as the boss, etc.)

Another option is to send a voice prompt as the message, which will be played to the receiving party (canned voice message, such as “please set a meeting with caller”, “take care of this” etc.). The receiver may then request to listen again to the message, answer the caller, etc. In this case there is a need for an IVR or Intelligent Peripheral infrastructure to allow playing the messages.

By still another embodiment of the invention, the private network comprises a WLAN network. If in such a case the incoming call is a voice call, then the method provided by the present invention further comprises a step of selecting a path of rerouting the call to the mobile station either along the WLAN network or along the public cellular network, in accordance with at least pre-defined criterion, such as the quality of the call being rerouted. Consequently, the wireless centrex users will be able to leverage WLAN infrastructure of their company and while when the user is in another location, the voice call can be routed via the WLAN (Voice over WLAN—VOWLAN), this will enable companies to have better local reception and enable the wireless operator to use their mobile network more efficiently, which in return allows leveraging the data network while saving money on expansion of the base stations). In addition, by this embodiment the mobile operator may have one billing plan for “local” calls originated from home WLAN, and a different billing plan for calls initiated from out of the home LAN.

Typically, the voice call is automatically connected to a WLAN and routed along that network. When the local signal is better or there is any other pre-defined rule governing such a scenario, e.g., all local calls will be routed over WLAN whenever in range or VOWLAN enabled only on own company premise (because in other locations the quality of the infrastructure is unknown), use VOWLAN if external voice quality is less than a pre-defined threshold, etc.)

In accordance with another embodiment of the invention, the method provided allows merging of IP Telephony features, WLAN capabilities, and/or Wi-Max capabilities under the cellular flow architecture umbrella, in a way that the IP based subscribers may be provided with any of the WX cellular services and features. The WX will allow merging between the IP world and the features associated therewith and the cellular network and WX features, preferably in a way that ensures that the IP WX subscriber will be provided with the same capabilities as a regular cellular subscriber.

In accordance with another embodiment of the invention, the method further comprises a step of providing a pre-defined auto reply to a calling party in response to a call received at the mobile station. Such pre-defined auto reply can be an e-mail, an SMS, a voice message, and the like. Therefore, the end user may define his line to send such an auto reply to the calling party, providing the latter by using TTS or wav type of file with any details desired such as “I am out of my office”, “will return on ______ ”, “will have limited access to my voice mailbox”, etc. Preferably, the type of the pre-defined auto reply is selected based on the type of the device originating the incoming call (e.g. wireless and wireline). For wireless party originating the call, the message can be in a form of SMS, while for a wireline the message may be in the form of an e-mail or a voice announcement.

In addition, the method of the present invention may further comprise a step of transmitting from the public cellular network center, audio signals and/or video signals while the call with the mobile station is being established or the call is being kept on hold. Preferably, the audio signals and/or video signals are selected in response to identifying the type of the device initiating the call. In addition, these audio or video signals may selected from among a plurality of audio or video clips, where the selection is based on one or more selection criteria such as the number called, caller ANI, time of the day, group number called, physical location of called subscriber, presence of called subscriber, International Mobile Equipment Identity (“IMEI”), and the like.

Furthermore, it is possible for the company's administrator to associate the whole company with the same music/video that will be played whenever a call is in queue or on hold, depending of course on the caller's device. If no indication is provided as to the capabilities supported by the caller's device, some default audio clips, such as music, branded messages, or announcements etc. may be played.

By this embodiment, video sessions may be established with the callers (provided of course the system identifies them as having the equipment required for establishing such a session), enable a company to promote its own business by sending pictures/video to the callers for them to view (e.g., marketing data, video of a product).

According to still another embodiment of the invention, if a request for establishing a communication session has not been answered within a pre-defined period of time by a user associated with the telephone number specified in that request, the request will re-routed towards a new communication address (e.g. voice mail address, web site, another telephone number, etc.) in accordance with a pre-defined management rule.

In accordance with yet another embodiment of the invention, the method provided may further comprise a step of forwarding a call to an answering service associated with the public cellular network center and have the message that will be left thereat by the caller, if not in office (or in case of overflow). The message will be forwarded to the mobile station, either automatically, or in response to the mobile station request to pull the messages received. Preferably, the mobile station is selected by the answering service center from among a plurality of mobile stations in accordance with a list of addresses provided to the provider of that answering service.

According to yet another embodiment, a replacing station may be provided which is operative to receive arriving calls instead of the mobile station to which the call was destined. Such replacement may be in response to a request sent by the mobile station to the public cellular network center. Preferably, the replacing station is selected from a routing list stored at the public cellular network center.

This embodiment enables the user to change to various pre-defined presence scenarios. The presence scenarios and routing instruction are stored in the cellular network center, and preferably each presence scenario will be associated with suitable operative instructions, for example: “in meeting” scenario will be translated by the network so that all arriving calls should be forwarded to the secretary's station. Once the mobile station user changes the scenario, a message is sent to wireless centrex, which will handle incoming calls based on the predefined routing rules.

According to yet another embodiment, selected subscribers may get an indication as to the whereabouts of other group members, e.g. a secretary may get an indication as whether the boss is present, support manager can view all support employees presence, while support employees will be prevented from viewing each other or their boss' presence.

In accordance with still another embodiment of the invention, incoming calls to a WX subscriber can be routed based on the subscriber's location, e.g. create different routing tables while the subscriber is in the office, at home or out of office, where the routing may be effected automatically, based on the location of the subscriber.

By yet another embodiment of the invention, the method provided further comprises a step of providing the mobile station with a voice prompt indicating that an arriving call is being transferred.

In addition or in the alternative, the enterprise management administrator may configure and define routing rules for all the company's employees. For example, the administrator may enable selected people to control and define selected groups, e.g. a secretary may thus define his/her boss calls' routing scheme, sales manager can control the respective sales group, etc. Furthermore, the administrator may be provided with the ability to carry out selected functionalities such as, add, delete freeze employee line, define groups, configure routing schemes per line (line can be a group, company main line, or employee's direct line), configure a conference call for another hour, etc.

By still another aspect of the present invention, there is provided a cellular telephone device comprising a blue tooth means adapted to allow communication between the cellular telephone and a computer device located nearby, so that when a call arrives at the cellular telephone device it will be automatically (or upon pressing a pre-defined key whether prior to the arrival of the call, or after the cellular telephone has started to ring) sending call control data to that computer device, allowing the handling of the call through the use of the computer device (e.g. such as a softphone, etc.)

In accordance with yet another embodiment, a transfer message is sent from the cellular network center to trigger an arriving call being placed on hold.

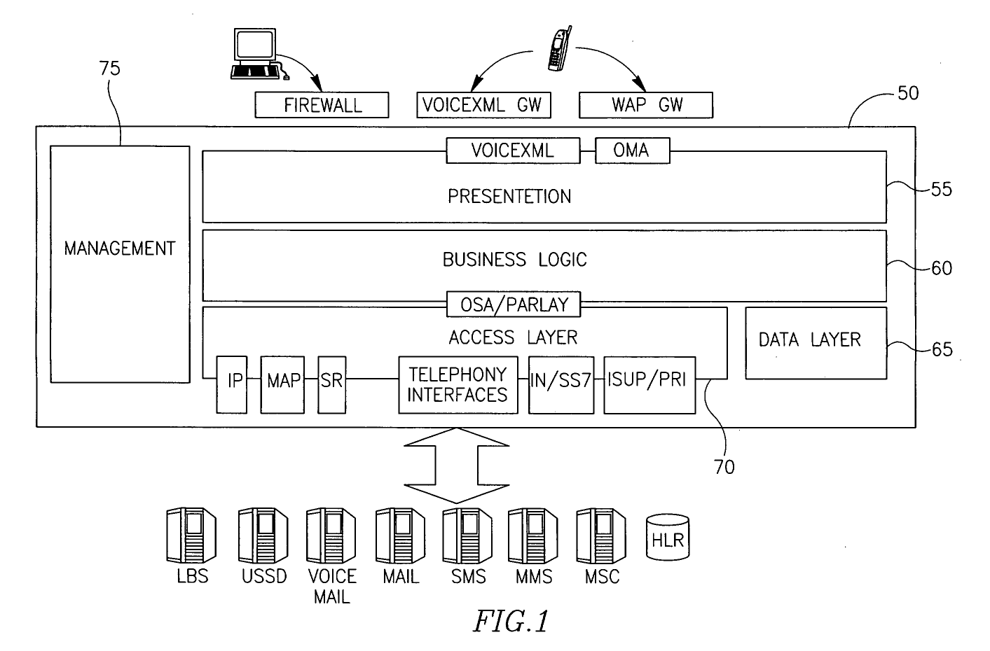

Let us now consider FIG. 1, which presents a schematic diagram of a WX example platform 50 constructed in accordance with the present invention. The WX platform demonstrated comprises the following main layers:

Presentation layer 55, which comprises management interfaces such as mobile operator administrator, enterprise administrator, and End users, and allows access to them via PC, wireless devices, etc.

Application/business Logic layer 60—comprises the business logic of the application, including features such as call routing, multi device ringing, transfer, conference, voice auto attendant, etc.

Data layer 65—comprises data server, database, data backup, storage, etc.

Access layer 70—the layer connects to the network infrastructure handling signaling, call control server, telephony and IP interfaces and gateways. Examples for the functionalities that may be included in this layer are: IP, Mobile Application Protocol (MAP), Speech Recognition (SR), Integrated Services digital network User Part (ISUP); Primary Rate Interface (PRI}, etc.

Management layer 75—the layer which include OMAP layer (e.g. OSS, BSS, monitoring, alerts, SNMP, provisioning, etc.)

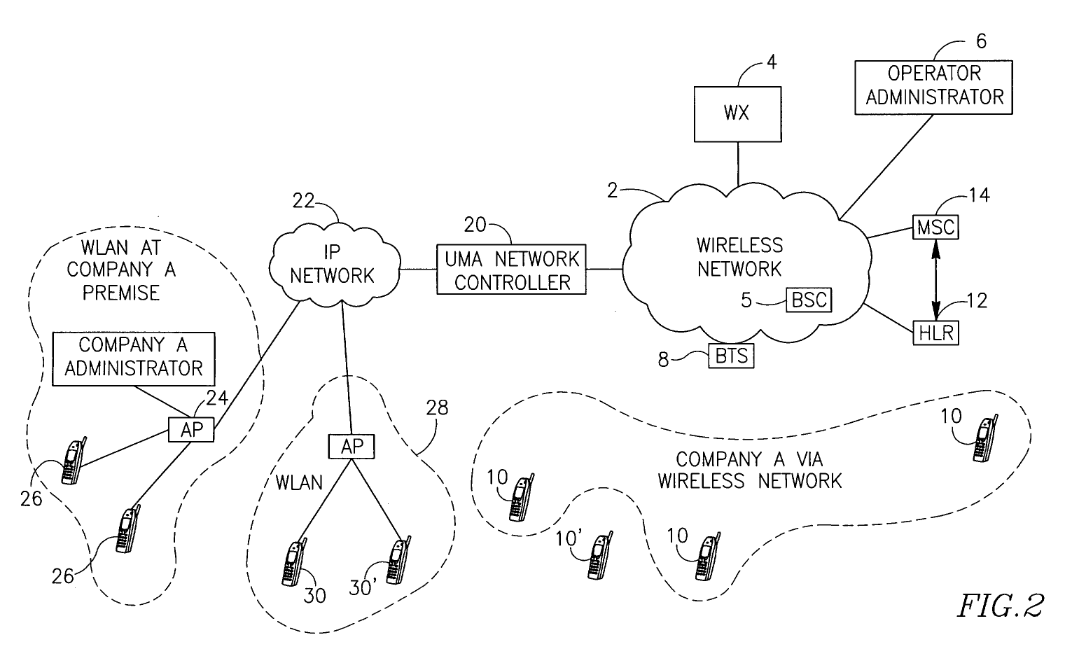

Let us now turn to FIG. 2, which illustrates a wireless network 2 operative in accordance with an embodiment of the present invention. The network comprises, as normally all wireless networks do, base station controller (“BSC”) 5, mobile switching center (“MSC”) 14, HLR 12, BTS 8 and the operator's management system 6, as well as a plurality of mobile stations, such as cellular phones 10 and 10′. In addition, the network described herein further comprises a wireless centrex device (“WX”) 4 constructed in accordance one or more of the embodiments of the present invention.

For the sake of this example, we assume that all cellular phones designated in this FIG. 2 with numeral 10, belong to users that are associated with company A which is a subscriber for the WX service, while cellular telephone 10′ belongs to a user that does not belong to company A organization.

The wireless network 2 according to this FIG. 2 is in communication with IP network 22 through UMA network controller 20. IP network 22 is associated with a number of access points (“AP”) 24, wherein each of these access points acts as a gateway connecting a corresponding wireless local area network (WLAN) with the IP network 22. As will be appreciated by those skilled in the art, may other arrangements may be used e.g. a PSTN network instead of the IP network (with corresponding COs instead of the APs, etc.)

Let us first consider a case where subscriber 10′, which is not part of organization A, calls company A sales group number. The request to establish this call reaches wireless network 4, processed and the address associated with that request is identified as one that belongs to wireless centrex service. Following this identification, the request is routed to wireless centrex 4 for further handling. At wireless centrex 4 there is a pre-defined list of telephone numbers the wireless centrex identifies this as a call for company A and then identifies by applying the list of telephone numbers of sales persons associated with that sales group number, subscribers 10 and 30. Wireless centrex 4 receives the input of the number requested, and determine that the call should be established with the either one of subscribers 10 and 30. The WX communicates with HLR and/or MSC 14 which will determine through which of the BTSs associated with wireless network 2, should this call be routed. BTS 8 is selected based on the presence of subscriber 10, while subscriber 30 will be reached via UMA network controller 20, through IP network 22 and AP 24. All four subscribers shown in this example, receive the request to establish a call (e.g. telephone ringing), and once the first of this group accepts the call, the other three mobile station will stop ringing.

Let us now consider another example where a request for establishing a call with company A's subscriber 10, is initiated by a caller 30 from WLAN 28. The request is processed through IP network 22 and conveyed to wireless network 4. The request is processed and the address associated with that request is identified as one that belongs to company A. Following this identification, the request is routed to wireless centrex 4 for further handling. Let us assume now for the sake of this example, that the request was placed for the number associated with the sales department. At wireless centrex 4 there is a pre-defined list of telephone numbers of sales persons associated with the sales department number, preferably arranged by priorities. Wireless centrex 4 receives the input of the number requested, and determine that the call should be established with the first number of the list associated with the number dialed. The WX communicate with HLR and/or MSC 14 which will determine through which of the BTS's associated with wireless network 2, should this call be routed, wherein BTS 8 is selected based on the presence of subscriber 10, to whom the call is now being routed, in a cell covered by BTS 8. The subscriber receives the request to establish a call, he/she will preferably also receive prior to establishing the call an indication of the original number that was dialed by subscriber 30′ of WLAN 28 with or without an indication of the WLAN subscriber's identity, and thereafter subscriber 10 accepts the call.

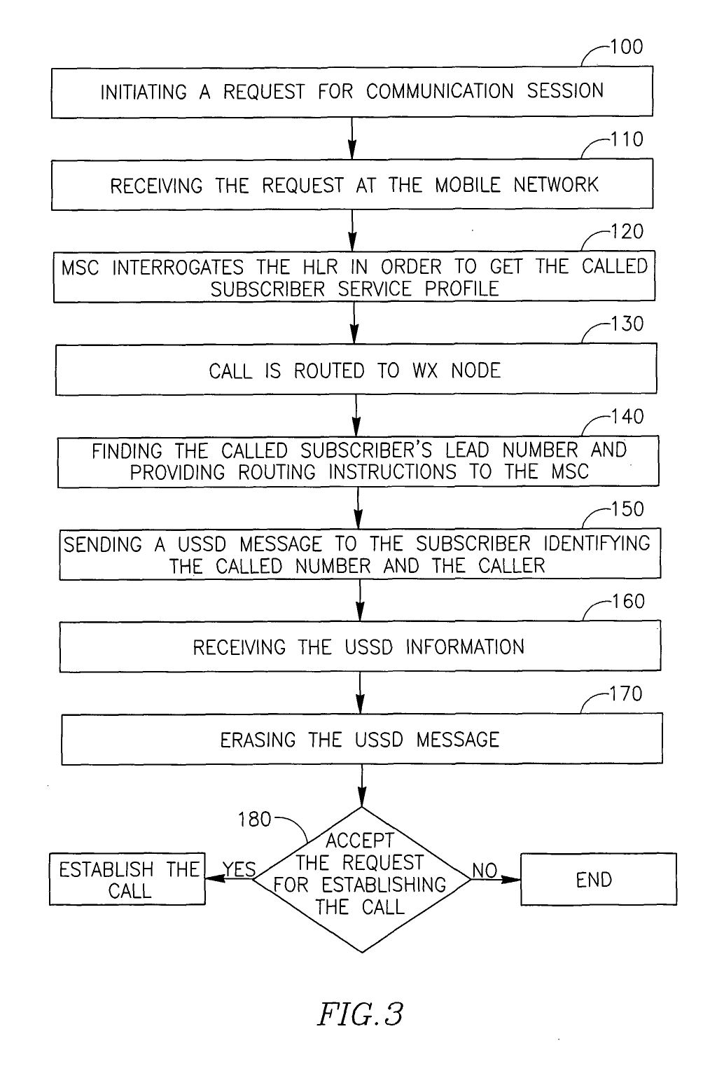

FIG. 3 illustrates a flow chart demonstrating an example of implementing the solution provided by the present invention. This example concerns an inbound voice call addressed to a mobile user, in which a cellular network communication device, the wireless centrex also operates as an IN signaling node.

By this example, a request is initiated to establish a communication session, e.g. a telephone call, with a certain subscriber of a mobile network that is also a subscriber of the wireless centrex system (step 100). The request may either be initiated by a user belonging to that mobile network, or from any external network (i.e. PSTN). Similarly, the request may be in the form of an e-mail sent to the user's e-mail address, for presenting it on his mobile device.

The request enters the mobile network (step 110) via a Gateway Mobile Switching Center (GMSC), for example: a call from the PSTN with a mobile dialed number will be routed to the GMSC, and received at a MSC/GMSC of the mobile network.

The MSC/GMSC then interrogates the HLR (step 120), in order to get the called subscriber service profile. According to the HLR's Terminate IN Key, the IN signaling of the call is routed toward a wireless centrex node (“WX”) of the present invention. Alternatively, the IN signaling of the call will be routed toward the WX according to the dialed number (e.g. all numbers between “1001” and “1100” should be routed to the WX) (step 130).

The wireless centrex then receives details about the call initiator (i.e. ANI, called number, if the subscriber is attached to the network or the last VLR update).

The subscriber of this example has several lines associated with his one device (different addresses), all of which are managed by the WX node. The subscriber has one lead (e.g. default) number and a list of additional numbers (addresses) is associated at the WX node with that subscriber. When a call is received on any of the subscriber's lines, the following process is initiated.

At the WX, the number dialed is matched against the pre-defined list, and the appropriate lead number for the subscriber is determined, and based on the information available, e.g. the lead number, routing tables, rules and other information, returns to the MSC with routing instructions for that call (step 140). In some cases, in which the mobile network has limited IN capabilities, or additional resources are needed, the WX may request to route the call to the WX Service Node, which will physically control and route the call.

A USSD message is then sent to the subscriber's lead number at his mobile device preferably with information regarding the called number and ANI of the caller (step 150).

The subscriber receives the information embedded in the USSD message while his telephone is ringing (step 160).

The subscriber presses any key and USSD message is erased (step 170).

The Subscriber views the regular incoming call screen, and can accept or reject the call (step 180)

As an alternative, the subscriber may receive in step 160 the USSD message before the telephone is ringing. Then the subscriber may select an action from a known list. The USSD will transfer the selection to WX node, which will route the call based on subscriber selection and other parameters that are stored at the management of the WX.

The MSC will route the call based on the instructions it received from the WX, while the latter will continue to manage the call and receive updates regarding the call status (e.g. once the call is disconnected the MSC will send the information to the WX via signaling) (step 150). Based on the call information, the WX routing tables and rules and other parameters, the WX will decide if and when to make changes in respect of this call.

In addition to the above, certain other features may be added as part of a wireless centrex solution:
Location based services (LBS) related features—routing based on location as described hereinbefore.
E911—the system may provide 911 capabilities based on data collected from wireless operator network location system.
Night service, weekend service, holiday service—various routing plans.
Company wide feature enforcement and ability to create uniformity across all company wireless phones, for example, once any incoming call to any extension, was not answered and it is after 17:00, the call is transferred to a specific number. (enables people that are working after 17:00 to answer call, but if called does not answer, enables the company to have somebody handling the call)
Door Bell group—open company door, could be limited to location (receive ring), time of the day, code to open door but can be applied from distance. In addition can use wireless device to view video picture via video camera at company door, recognize visitor and open door.
Lock device—enterprise administrator can lock certain devices/lines via company web interface.
Call one number (i.e. sales number) multi device wireless phones ring.
Routing of calls to called number, which is abroad based on ANI (not based on code, or in addition to code—users will enter code or based on their ANI will be transferred to subscriber roaming).
Routing of calls and content (e.g. video call or voice call) to a called number based on called number IMEI (International Mobile Equipment Identity).

Furthermore, when a new user is added to the organization, the company address book can be automatically updated and the company public address book OTA sent to the new user.

As could be appreciated from the above description, the present invention seeks to provide solutions that answer some or all of the following enterprises needs:

Lower Total Cost of Ownership of voice communication infrastructure. In accordance with the present invention this is achieved by eliminating the duplicate networks (i.e. wireline and wireless), systems (i.e. PBX, voice mail), duplicate voice terminals (i.e. wireless telephone, desktop telephone), and the duplication of features (i.e. two voice mails) across the various solutions.

Enhancing productivity of employees' communications and company processes, by higher percentage of successful calls (less phone tag).

Providing Mobility with all functionality of the current local voice communication systems (i.e. PBX).

System and management Simplicity:

One voice communication solution, which enables enterprises to manage and define routing rules for all voice communication at all locations (on premise and off premise);

No need for more than one communication device per employee, thus enabling the employees to eliminate duplication of devices and services (i.e. wireless device and desktop device, two voice mails etc.)

Low set up costs and on going predictability of service cost by providing the ability to the client enterprise to purchase the number of devices as well as the services it requires, while keeping the ability to instantly expand or reduce subscriptions. For example, when the alternative is a PBX, there are many limitations associated with such a solution, number of extensions per PBX, number of lines in a line card, number of extensions in an extension card, if there is a need to expand, it entails most probably purchasing more then is presently required, e.g. new line/extension card or new PBX in cases outgrew PBX, even if there is a need to add only one more extension as there is no way to provide interim growth. Also, in case the number of extensions are reduced there is no possibility to return what has already been purchased.

Robust solution—reliability & availability, disaster recovery

Freeing the enterprises from supporting and operating complex communications solutions. The solution offered by the present invention provides for the enterprise a system which is set up, operated and maintained by professional service provider employees, together with a user-friendly web management interface that enables the enterprise end users to configure the system as needed (i.e. user, secretary, admin).

Enables uniformity of communication service to their customers and suppliers, one number per employee, which maintains all call functionality no matter where employee is located (i.e. if the boss secretary answers call while he/she is in the office, same logic and routing can be applied while out of the office, and the caller experience will be the same).

It will be appreciated that although various aspects of the invention have been described with respect to specific embodiments, alternatives and modifications will be apparent from the present disclosure, which are within the spirit and scope of the present invention as set forth in the following claims. For example, enterprise management can be done by web management or by any other method such as using wireless device, using voice call etc.) as long as the enterprise is provided with the ability to control and define how the routing of its employees' mobile devices will be implemented (i.e. set rules, create company wide features and parameters)

1-55. (canceled)

56. A method for routing a request to establish a communication session via a communication address associated with a private network, wherein said request is routed via a public cellular network, and for establishing said communication session, said method comprising:
establishing a pre-defined list of telephone numbers belonging to said private network;
associating each of said telephone numbers with at least one communication address;
defining at least one management rule for handling requests for establishing communication sessions with at least one of said communication addresses;
receiving a request to establish said communication session, wherein at least one telephone number selected out of said pre-defined list of telephone numbers is associated with said request;
routing said request towards a communication address associated with said at least one telephone number, and wherein said routing is carried out in accordance with said at least one management rule;
associating a message with the communication session being established for display at a user's device associated with said communication address; and
establishing a communication session between the originator of the arriving request for communication session and a user associated with said communication address, via at least one center of the public cellular network.

57. A method according to claim 56, wherein said message associated with the communication session being established is transmitted to a mobile station by using USSD.

58. A method according to claim 56, wherein said message associated with the communication session being established is transmitted by using a real time data message via a data communication channel.

59. A method according to claim 56, wherein said message comprises identification of the communication address called by the device initiating the request for establishing said communication session.

60. A method according to claim 56, further comprising a step of diverting a communication session received at a mobile station to another station associated with said private network in response to a request initiated by said mobile station.

61. A method according to claim 60, further comprising a step of associating a message with said diverted communication session.

62. A method according to claim 61, wherein said message is generated in response to a pre-define code sent from said mobile station.

63. A method according to claim 62, wherein at least one key of said mobile station is translated to a corresponding message for display at said another station.

64. A method according to claim 56, further comprising a step of providing a pre-defined auto reply to a calling party in response to a request for communication session received at said mobile station, and wherein said pre-defined auto reply is selected based on the type of the device originating the incoming request for communication session.

65. A method according to claim 56, further comprising a step of forwarding a communication session to an answering service associated with said at least one center of said public cellular network and having the message left thereat, forwarded to said mobile station.

66. A method according to claim 65, wherein said mobile station is selected by said answering service from among a plurality of mobile stations in accordance with a list of addresses provided to the provider of said answering service.

67. A method according to claim 56, further comprising a step of sending a transfer message from said at least one center of said public cellular network to trigger an arriving communication session being placed on hold.

68. A cellular network communication device operative to allow establishing of a communication session with a user of a communication address belonging to a private network, which comprises:
means for establishing a pre-defined list of telephone numbers belonging to said private network;
means for associating each of said telephone numbers with at least one communication address;
means for defining at least one management rule for handling requests for establishing communication sessions directed to at least one of said communication addresses;
means for receiving a request to establish a communication session that specifies at least one telephone number which belongs to said pre-defined list of telephone numbers;
means for establishing a communication session between the request's originator and a user associated with a communication address associated with said at least one telephone number, and wherein said communication session is established in accordance with that at least one management rule; and
means for associating a message with the communication session being established for display at said mobile station.
